(19) United States
(12) Patent Application Publication
(10) Pub. No.: US 2026/0095829 A1
(43) Pub. Date: Apr. 2, 2026

(54) HANDLING TRAINING DATA COLLECTION CONFIGURATION DURING UE MOBILITY

(71) Applicant: QUALCOMM Incorporated, San Diego, CA (US)

(72) Inventors: Rajeev KUMAR, San Diego, CA (US); Shankar KRISHNAN, Poway, CA (US)

(21) Appl. No.: 19/333,063

(22) Filed: Sep. 18, 2025

Related U.S. Application Data
(60) Provisional application No. 63/701,483, filed on Sep. 30, 2024.

(51) Int. Cl. H04W 36/08; H04L 41/16; H04W 76/19; H04W 76/20; H04W 76/30

(52) U.S. Cl. CPC H04W 36/08; H04L 41/16; H04W 76/19; H04W 76/20; H04W 76/30

(57) ABSTRACT

Apparatus, methods, and computer program products for wireless communication are provided. An example method may include receiving, from a first network node, a first training data collection configuration and a first identifier (ID) associated with the first training data collection configuration and the first network node, where the first ID is indicative of a first vendor associated with the first network node. The example method may further include obtaining a set of training data based on the first training data collection configuration and the first ID. The example method may further include receiving, based on a handover from the first network node to a second network node, a second ID associated with the second network node, where the second ID is indicative of a second vendor associated with the second network node.

### CROSS REFERENCE TO RELATED APPLICATION(S)

This application claims the benefit of and priority to U.S. Provisional Application Ser. No. 63/701,483, entitled “HANDLING TRAINING DATA COLLECTION CONFIGURATION DURING UE MOBILITY” and filed on Sep. 30, 2024, which is expressly incorporated by reference herein in its entirety.

### TECHNICAL FIELD

The present disclosure relates generally to communication systems, and more particularly, to wireless communication systems with user equipment (UE) mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a first network node, a first training data collection configuration and a first identifier (ID) associated with the first training data collection configuration and the first network node, where the first ID is indicative of a first vendor associated with the first network node. Based at least in part on information stored in the at least one memory, the at least one processor, individually or in any combination, is configured to obtain a set of training data based on the first training data collection configuration and the first ID. Based at least in part on information stored in the at least one memory, the at least one processor, individually or in any combination, is configured to receive, based on a handover from the first network node to a second network node, a second ID associated with the second network node, where the second ID is indicative of a second vendor associated with the second network node.

In another aspect of the disclosure, a method, a computer-readable medium, and an apparatus at a first network node are provided. The apparatus may include at least one memory and at least one processor coupled to the at least one memory. Based at least in part on information stored in the at least one memory, the at least one processor, individually or in any combination, is configured to (e.g., case the first network node to) transmit, for a user equipment (UE), a first training data collection configuration and a first identifier (ID) associated with the first training data collection configuration and the first network node, where the first ID is indicative of a first vendor associated with the first network node. Based at least in part on information stored in the at least one memory, the at least one processor, individually or in any combination, is configured to transmit, for the UE upon a handover of the UE to a second network node, a second training data collection configuration and a second ID associated with the second training data collection configuration and the second network node, an indication of a release of the first training data collection configuration, or an indication of a pause of the first training data collection configuration.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an illustrative block diagram of an example machine learning (ML) model represented by an artificial neural network (ANN), in accordance with various aspects of the present disclosure.

FIG. 5 is an illustrative block diagram of an example ML architecture 500 that may be used for wireless communications in any of the various implementations, processes, environments, networks, or use cases, in accordance with various aspects of the present disclosure.

FIG. 6 is an illustrative block diagram of an example ML architecture of first wireless device in communication with second wireless device, in accordance with various aspects of the present disclosure.

FIG. 7 is a diagram illustrating an example of measurement resources and prediction targets, in accordance with various aspects of the present disclosure.

FIG. 8 is a diagram illustrating example communications between a first network node, a second network node, and a UE.

FIG. 9 is a diagram illustrating example communications between a first network node, a second network node, an operations administration and maintenance (OAM), and a UE.

FIG. 10 is a diagram illustrating example communications between a first network node, a second network node, an OAM, and a UE.

FIG. 11 is a diagram illustrating example communications between a first network node, a second network node, an access and mobility function (AMF), an OAM, and a UE.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein may provide mechanisms for handling training data collection configuration during handover and radio resource control (RRC) state transition, which enables the UE to be configured with training data collection configuration after handover and RRC state transition.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

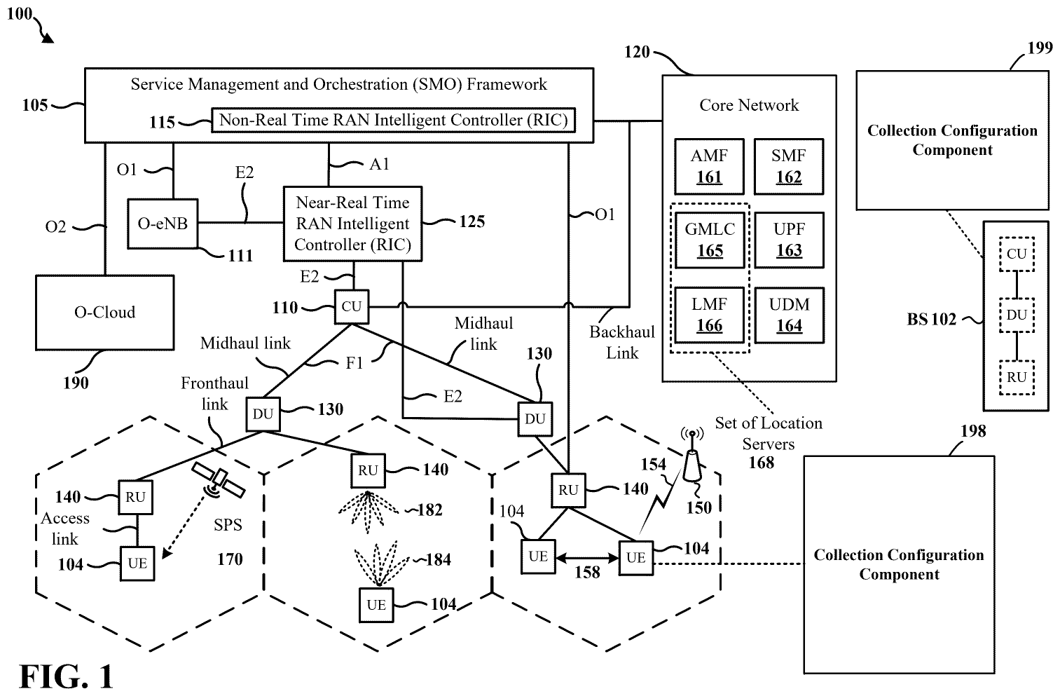

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a collection configuration component 198. In some aspects, the collection configuration component 198 may be configured to receive, from a first network node, a first training data collection configuration and a first identifier (ID) associated with the first training data collection configuration and the first network node, where the first ID is indicative of a first vendor associated with the first network node. In some aspects, the collection configuration component 198 may be further configured to obtain a set of training data based on the first training data collection configuration and the first ID. In some aspects, the collection configuration component 198 may be further configured to receive, based on a handover from the first network node to a second network node, a second ID associated with the second network node, where the second ID is indicative of a second vendor associated with the second network node.

In certain aspects, the base station 102 may include a collection configuration component 199. In some aspects, the collection configuration component 199 may be configured to transmit, for a user equipment (UE), a first training data collection configuration and a first identifier (ID) associated with the first training data collection configuration and the first network node, where the first ID is indicative of a first vendor associated with the first network node. In some aspects, the collection configuration component 199 may be further configured to transmit, for the UE upon a handover of the UE to a second network node, a second training data collection configuration and a second ID associated with the second training data collection configuration and the second network node, an indication of a release of the first training data collection configuration, or an indication of a pause of the first training data collection configuration.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

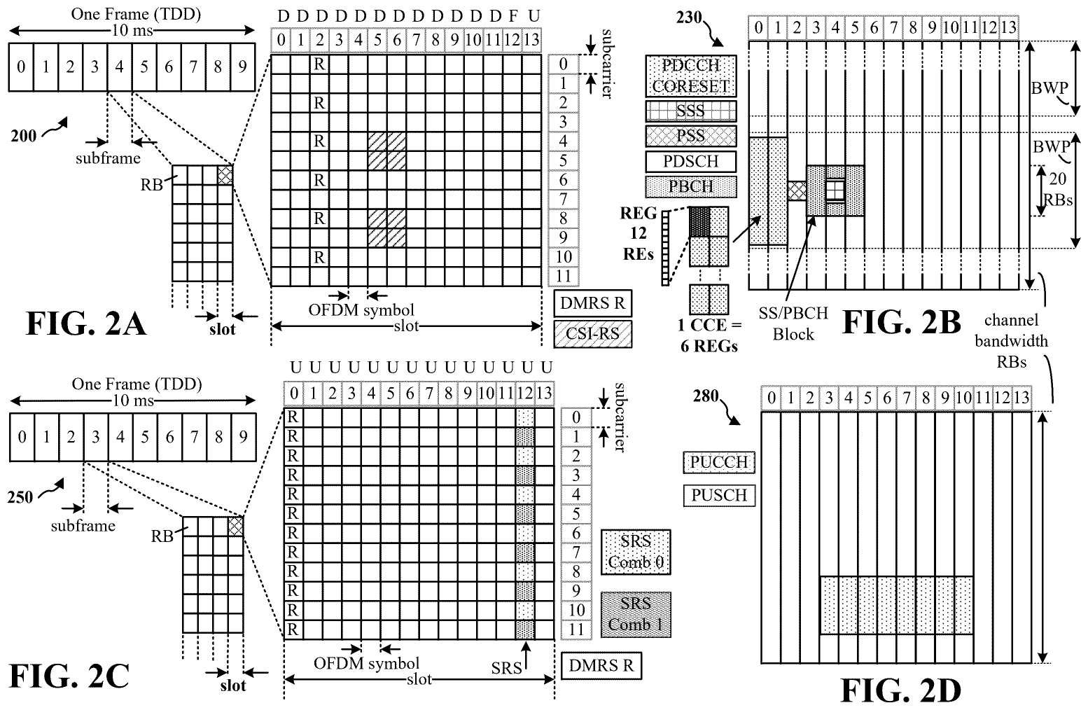

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

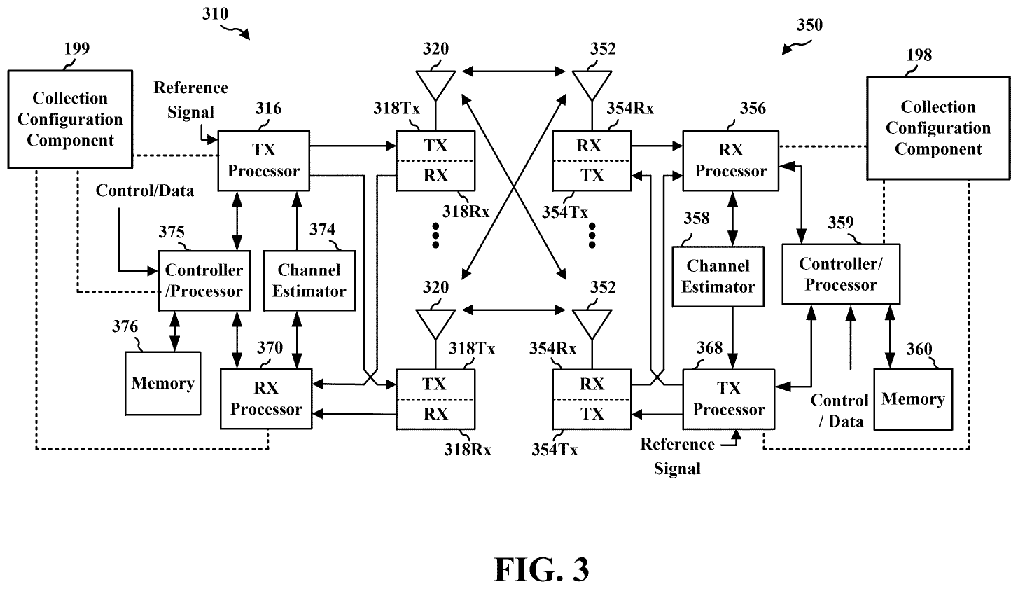

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with collection configuration component 198 of FIG. 1.

At least one of the TX processor 316, the RX processor 370, and the controller/processor 375 may be configured to perform aspects in connection with collection configuration component 199 of FIG. 1.

As used herein, the term “training stage” may refer to the process of training an AI/ML model for spatial or temporal domain DL transmit beam prediction for set-A of beams based on measurement results of set-B of beams. As used herein, the term “measurement resources” or “set-B beams” may be used interchangeably to refer to a set of measurement resources associated with one or more spatial filters (which may be referred to as “beams”) that may be used to train (which may be referred to as a “training stage” or “training”) an AI/ML model at the UE to predict (which may be referred to as an “inference stage” or “inference”) DL transmission associated with a set of “prediction targets” or “set-A beams.” As used herein, the term “prediction result,” “predicted measurement characteristics,” or “predicted channel characteristics,” may be used interchangeably to refer to predicted metric(s), such as predicted reference signal received power (RSRP) or other metrics (e.g., a channel quality indicator (CQI), a signal-to-noise ratio (SNR), a signal-to-interference plus noise ratio (SINR), a signal-to-noise-plus-distortion ratio (SNDR), a received signal strength indicator (RSSI), or a reference signal received quality (RSRQ), and/or a block error rate (BLER)) associated with prediction target(s).

The measurement resources and the prediction targets, along with an AI/ML model associated with the measurement resources and the prediction targets, may be associated with an associated ID. The associated ID may be a dataset, configuration, scenario, codebook, functionality, and model identifier that identifies network side additional conditions related with UE assumptions associated with AI/ML life cycle management including data collection, training, deployment, inference, performance monitoring, activation, deactivation, and switching. In some aspects, as long as the same associated ID is identified across training and inference, network side additional conditions may be assumed to be the same by the UE across training and inference. During the training stage, reference signal(s) such as a synchronization signal block (SSB), a channel state information (CSI)-reference signal (CSI-RS), or a demodulation reference signal (DM-RS), may be transmitted on the measurement resources. Reference signal(s) may also be transmitted on the prediction targets during the training stage. During the prediction stage, reference signal(s) may be transmitted on the measurement resources and the UE may output prediction result(s) on the prediction target(s) based on a set of assumptions (e.g., generated or updated during the training stage) associated with the ID. In some aspects, each prediction result may be mapped to a particular beam ID or a set of beam IDs associated with the prediction target(s).

A UE may be requested by network to predict (e.g., generate “predictions” or “prediction result”) and report channel characteristics on a set of prediction targets associated with set-A network node Tx beams, based on at least measurements on a set of measurement resource RSs associated with set-B network node Tx beams, through various prediction cycles and for each prediction cycle to be regarding various target temporal prediction instances.

As used herein, the term “measured characteristic” may refer to measured channel characteristic based on various information, such as information based on RSRP, CQI, SNR, SINR, SNDR, RSSI, RSRQ, BLER, that may be measured based on one or more RSs on measurements resources or one or more RSs on the prediction targets. As used herein, the term “channel characteristic” may refer to at least one of: top K targets with regard to L1-RSRP/SINR together with their predicted L1-RSRPs/SINRs, IDs of the top K targets with regard to L1-RSRP/SINR, probabilities of the target(s) being top1/top K target(s) with regard to L1-RSRP/SINR together with their top K target IDs, or the like, where K may be a positive integer configured by the network or configured independent of signaling from the network (e.g., defined without signaling).

The UE may be further scheduled by network to measure a set of performance monitoring RSs associated with one or more of the set-A network node Tx beams through various monitoring instances, and further calculate and feedback performance monitoring metrics and/or performance monitoring decisions based on particular performance monitoring metrics, taking measurements on the performance monitoring RSs at each monitoring instances together with the predicted channel characteristics on the prediction targets with regard to the prediction instance closest to the considered monitoring instance, into account. As used herein, RSs on the prediction targets that may allow the UE to measure the RSs to generate measured characteristic (also referred to as “measurements” or “measurement result”) on the prediction targets may be referred to as “monitoring RS.” The monitoring RSs may be carried in monitoring instances, which may be time instances for carrying RSs for prediction targets. In some aspects, each prediction target may be associated with a set of “monitoring instances.” In some aspects, among all monitoring instances associated with a prediction target, a first subset of the monitoring instances may include actually transmitted RSs and a second subset of the monitoring instances may not include transmitted RSs (e.g., may be empty and there may be no RS transmitted in the monitoring instance).

The measurement resources and the prediction targets, along with an AI/ML model associated with the measurement resources and the prediction targets, may be associated with an associated ID. The associated ID may be a dataset, configuration, scenario, codebook, functionality, and model identifier that identifies network side additional conditions related with UE assumptions associated with AI/ML life cycle management including data collection, training, deployment, inference, performance monitoring, activation, deactivation, and switching. In some aspects, as long as the same associated ID is identified across training and inference, network side additional conditions may be assumed to be the same by the UE across training and inference. During the training stage, reference signal(s) such as a synchronization signal block (SSB), a channel state information (CSI)-reference signal (CSI-RS), or a demodulation reference signal (DM-RS), may be transmitted on the measurement resources. Reference signal(s) may also be transmitted on the prediction targets during the training stage. During the prediction stage, reference signal(s) may be transmitted on the measurement resources and the UE may output prediction result(s) on the prediction target(s) based on a set of assumptions (e.g., generated or updated during the training stage) associated with the ID. In some aspects, each prediction result may be mapped to a particular beam ID or a set of beam IDs associated with the prediction target(s). There may be several iterations of the prediction stage and each iteration may be a “prediction cycle.”

Certain aspects and techniques as described herein may be implemented, at least in part, using an AI program, such as a program that includes a ML or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform spatial domain or temporal domain DL Tx beam prediction. Thus, during operation of a device, the ML model may receive input data (such as measurements on the measurement resources) and make inferences (such as spatial domain or temporal domain DL Tx beam prediction on the prediction targets, including reference signal received power (RSRP) or other metric prediction on the prediction targets) based on the weights and biases. ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, or the like.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), or the like.

The description herein illustrates, by way of some examples, how one or more tasks or problems in wireless communications may benefit from the application of one or more ML models. For example, based on aspects provided herein, performance of beams may be predicted and the UE may be able to more efficiently perform beam management. To facilitate the discussion, an ML model configured using an ANN is used, but it may be understood, that other types of ML models may be used instead of an ANN. Hence, unless expressly recited, subject matter regarding an ML model is not necessarily intended to be an ANN solution without other solutions. Further, it may be understood that, unless otherwise specifically stated, terms such “AI/ML model,” “ML model,” “trained ML model,” “ANN,” “model,” “algorithm,” or the like are intended to be interchangeable.

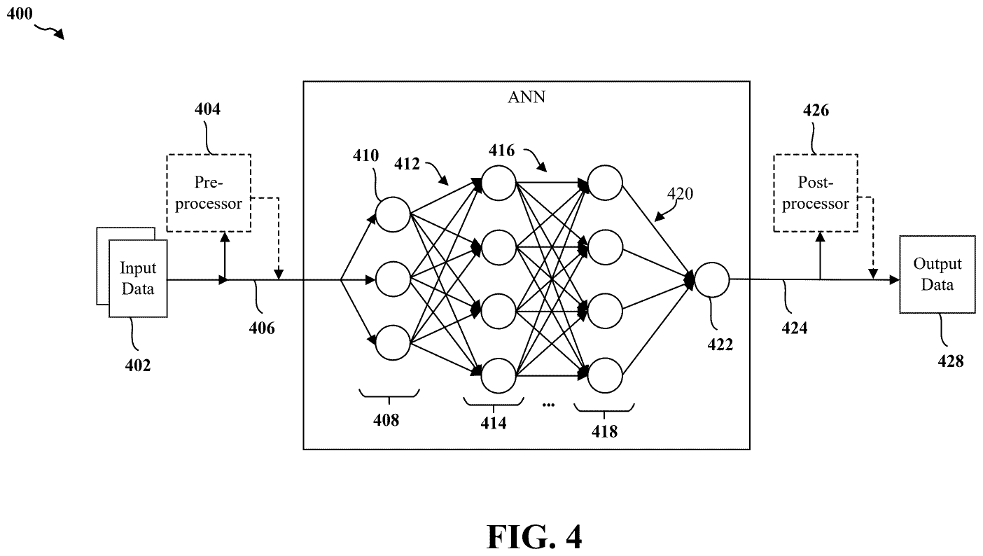

FIG. 4 is an illustrative block diagram of an example machine learning (ML) model represented by an artificial neural network (ANN), in accordance with various aspects of the present disclosure. ANN 400 may receive input data 406 which may include one or more bits of data 402, pre-processed data output from pre-processor 404 (optional), or some combination thereof. Here, data 402 may include training data, verification data, application-related data, or the like, based, for example, on the stage of deployment of ANN 400. Pre-processor 404 may be included within ANN 400 in some other implementations. Pre-processor 404 may, for example, process all or a portion of data 402 which may result in some of data 402 being changed, replaced, deleted, etc. In some implementations, pre-processor 404 may add additional data to data 402. In some implementations, the pre-processor 404 may be a ML model, such as an ANN.

ANN 400 includes at least one first layer 408 of artificial neurons 410 to process input data 406 and provide resulting first layer data via connections or “edges” such as edges 412 to at least a portion of at least one second layer 414. Second layer 414 processes data received via edges 412 and provides second layer output data via edges 416 to at least a portion of at least one third layer 418. Third layer 418 processes data received via edges 416 and provides third layer output data via edges 420 to at least a portion of a final layer 422 including one or more neurons to provide output data 424. All or part of output data 424 may be further processed in some manner by (optional) post-processor 426. Thus, in certain examples, ANN 400 may provide output data 428 that is based on output data 424, post-processed data output from post-processor 426, or some combination thereof.

Post-processor 426 may be included within ANN 400 in some other implementations. Post-processor 426 may, for example, process all or a portion of output data 424 which may result in output data 428 being different, at least in part, to output data 424, as result of data being changed, replaced, deleted, etc. In some implementations, post-processor 426 may be configured to add additional data to output data 424. In this example, second layer 414 and third layer 418 represent intermediate or hidden layers that may be arranged in a hierarchical or other like structure. Although not explicitly shown, there may be one or more further intermediate layers between the second layer 414 and the third layer 418. In some implementations, the post-processor 426 may be a ML model, such as an ANN.

The structure and training of artificial neurons 410 in the various layers may be tailored to specific conditions of an application. Within a given layer such as first layer 408, second layer 414, or third layer 418 of ANN 400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 400. The weights and biases of ANN 400 may be adjusted during a training process or during operation of ANN 400. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 406. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 400, may be conducted using training data. Training data may include one or more datasets which ANN 400 may use to identify patterns or relationships. Training data may represent various types of information, including written, visual, audio, environmental context, operational properties, etc. During training, the parameters (such as the weights and biases) of artificial neurons 410 may be changed, such as to minimize or otherwise reduce a loss function or a cost function. A training process may be repeated multiple times to fine-tune ANN 400 with each iteration.

Various ANN model structures are available for consideration. For example, in a feedforward ANN structure, each artificial neuron 410 in layer 414 receives information from the previous layer (such as, one or more artificial neurons 410 in layer 408) and produces information for the next layer (such as, one or more artificial neurons 410 in layer 418). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

ANN 400 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by an NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model. For example, the UE may be more inclined to use a particular set of spatial filters from the prediction targets that are associated with a better performing metric during DL reception. As another example, the UE may also predict when may the DL transmission arrive (e.g., as part of the prediction result) and adjust its RF transceiver accordingly.

In example aspects, an ML model may be trained prior to, or at some point following, operation of the ML model, such as ANN 400, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). As a particular example, during the training stage, reference signals and measured metrics associated with the measurement resources or the prediction targets may be used as input for the model training. Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, or the like.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned. Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent-based optimization algorithm and a stochastic gradient descent-based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases. An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade. Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances. Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model. One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, where the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network. Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

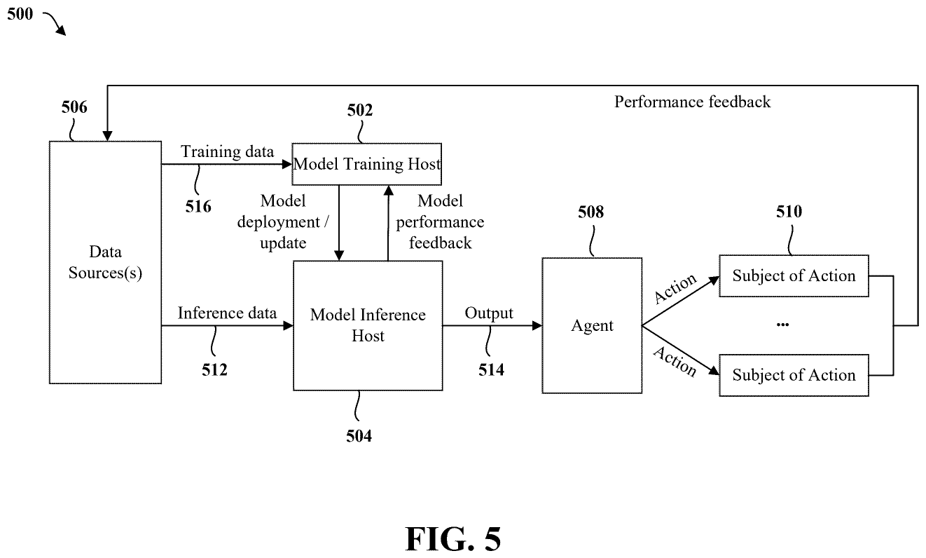

FIG. 5 is an illustrative block diagram of an example ML architecture 500 that may be used for wireless communications in any of the various implementations, processes, environments, networks, or use cases, in accordance with various aspects of the present disclosure. As illustrated, architecture 500 includes multiple logical entities, such as model training host 502, model inference host 504, data source(s) 506, and agent 508. Model inference host 504 is configured to run an ML model based on inference data 512 provided by data source(s) 506. Model inference host 504 may produce output 514, which may include a prediction or inference, such as a discrete or continuous value based on inference data 512, which may then be provided as input to the agent 508. Agent 508 may represent an element or an entity of a wireless communication system including, for example, a radio access network (RAN), a wireless local area network, a device-to-device (D2D) communications system, etc. As an example, agent 508 may be a UE, such as the UE 104 in FIG. 1. Additionally, agent 508 also may be a type of agent that depends on the type of tasks performed by model inference host 504, the type of inference data 512 provided to model inference host 504, or the type of output 514 produced by model inference host 504. Agent 508 may perform one or more actions associated with receiving output 514 from model inference host 504. For example, if the agent 508 determines to change or modify a transmit or receive beam for a communication between agent 508 and the subject of action 510, agent 508 may adjust reception beam. As an example, agent 508 may be a UE and output 514 from model inference host 504 may one or more predicted channel characteristics for one or more beams. For example, model inference host 504 may predict channel characteristics for a set of beams based on the measurements of another set of beams. Based on the predicted channel characteristics, agent 508, the UE, may send, to the BS, a request to switch to a different beam for communications. In some cases, agent 508 and the subject of action 510 are the same entity. Data can be collected from data sources 506, and may be used as training data 516 for training an ML model, or as inference data 512 for feeding an ML model inference operation. Data sources 506 may collect data from various subject of action 510 entities (such as, the UE or the network entity), and provide the collected data to a model training host 502 for ML model training. As an example, the data collected may include measured metrics associated with the measurement resources or the prediction targets.

Model training host 502 may be deployed at the same or a different entity than that in which model inference host 504 is deployed. For example, in order to offload model training processing, which can impact the performance of model inference host 504, model training host 502 may be deployed at a model server.

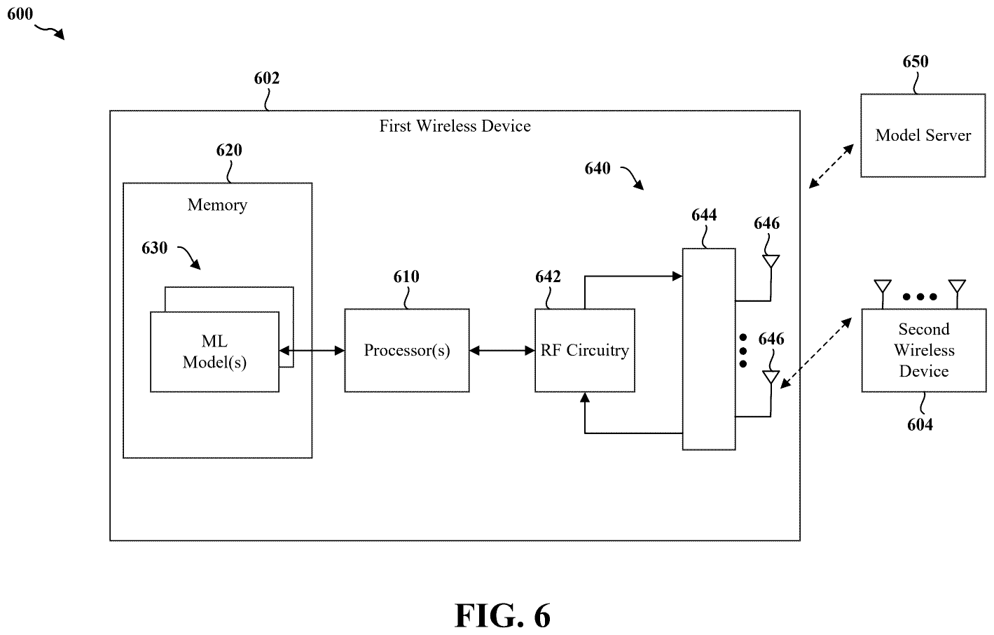

FIG. 6 is an illustrative block diagram 600 of an example ML architecture of first wireless device 602 in communication with second wireless device 604, in accordance with various aspects of the present disclosure. First wireless device 602 may be, or may include, a chip, system on chip (SoC), chipset, package or device that includes one or more processors, processing blocks or processing elements (collectively “processor 610”) and one or more memory blocks or elements (collectively “memory 620”). Processor 610 may be coupled to transceiver 640, which includes radio frequency (RF) circuitry 642 coupled to antennas 646 via interface 644, for transmitting or receiving signals.

One or more ML models 630 (collectively “ML model 630”) may be stored in memory 620 and accessible to processor(s) 610. Individual or groups of ML models 630 may be associated with respective model identifiers. In some aspects, different ML models 630, which may optionally be associated with different model identifiers, may have different characteristics. One or more ML models 630 may be selected based on respective features, characteristics, or applications, as well as characteristics or conditions of first wireless device 602 (such as, a power state, a mobility state, a battery reserve, a temperature, etc.). For example, ML models 630 may have different inference data and output pairings (such as, different types of inference data produce different types of output), different levels of accuracies associated with the predictions, different latencies associated with producing the predictions, different ML model sizes, different coefficients, different parameters, or the like.

Processor 610 may deploy ML models 630 to produce respective output data based on input data. For example, the ML models 630 may output predicted metric(s), such as predicted reference signal received power (RSRP) or other metrics associated with prediction target(s) based on measurements on the measurement resources. In some aspects, model server 650 may perform various ML management tasks for first wireless device 602 and/or second wireless device 604. For example, model server 650 may host various types and/or versions of ML models 630 for first wireless device 602 and/or second wireless device 604 to download. Model server 650 may monitor and evaluate the performance of ML model 630. Model server 650 may transmit signals or provide indications/instructions to activate or deactivate the use of a particular ML model at first wireless device 602 or second wireless device 604. Model server 650 may switch to a different ML model being used at first wireless device 602 or second wireless device 604, and model server 650 may provide such an instruction to the respective first wireless device 602 or second wireless device 604. Model server 650 may operate as a model training host (such as model training host 502) and update ML model 630 using training data. In some cases, the model server 650 may operate as a data source (such as data source 506) to collect and host training data, inference data, performance feedback, etc., associated with ML model 630.

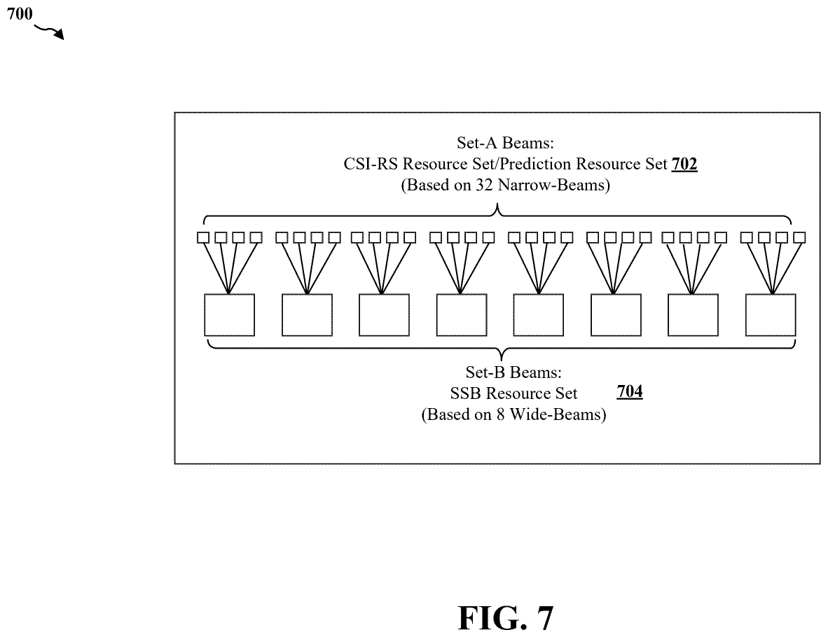

FIG. 7 is a diagram 700 illustrating an example of measurement resources and prediction targets. As illustrated in FIG. 7, a set of measurement resources 702, which may be CSI-RS resource set or a different type of prediction resource set, may include 32 narrow beams. The set of prediction targets 704 may include SSB resource set based on 8 wide-beams. Various types of parameter consistency across training and inference with regard to a same ID may be maintained. For example, quantity consistency such that the same quantities of SSBs, CSI-RSs, or other resources configured as measurement resources and prediction targets are expected across different groups of resources during training stage and inference stage. As another example, beam consistency such that relative pointing direction and beam width difference between physical beams with regard to different resources may remain the same across different SSB resource sets for different groups of resources during training stage and inference stage, across the CSI-RS resource set for training and the prediction resource set for inference. In some aspects, a Type D quasi-co-location (QCL) consistency may be used. For example, if the jth resource in a first group of resources in the training stage has a Type D QCL relationship with the kth resource in a second group of resources in the training stage, it may also be expected that the jth resource in a third group of resource in the inference stage has a Type D QCL relationship with the kth resource in the fourth group of resources in the inference stage. As another example, in some aspects, transmit power(s) associated with each resource associated with each measurement resource or prediction target associated with a same ID during inference and training may be within a same transmit power level range. Given a same ID, resource-wise quantity, order, Type D-QCL, beam-shape, transmit power level range, may be consistent across training and inference.

Spatial DL beam prediction for Set-A beams may be based on measurement results of Set-B beams. For example, Set-B beams may be SSB-like wide beams, while set-A beams are CSI-RS like narrow beams. As another example, Set-B beams are narrow beams, while Set-A beams are other narrow beams. Temporal DL beam prediction for Set-A beams may be based on the historic measurement results of Set-B beams. For example, set-A and set-B beams may be the same (e.g., corresponding spatial filters which may be pure temporal beam prediction). As another example, set-A and set-B beams are different (e.g., have different spatial filters) and spatial and temporal beam prediction may be performed. Associated ID may be provided or achieving consistency between training and inference. In some aspects, prediction at both network node and UE side may be performed and single cell scenarios may be considered.

For NW-side data collection related to beam management use cases, network node-centric and operations administration and maintenance (OAM)-centric approaches may be considered. Based on aspects provided herein, a same measurement framework may be applied to both network node-centric data collection and OAM-centric data collection for NW-side data collection. For network node centric and OAM centric (for RRC signaling between UE and network node), reporting multiple instances of logged L1 measurement result from UE to network node via an RRC message as configured by network node may be used. Immediate minimization of drive test (MDT) may be the baseline framework for OAM-centric data collection and it may be enhanced to support periodical reporting. Event-based reporting and network request reporting may also be supported.

As used herein, the term “training data collection configuration” may refer to a configuration for collection of training data which may include measurement objects configuration, report configuration, logging configuration, or the like.

Aspects provided herein may provide mechanisms for handling training data collection configuration during handover and radio resource control (RRC) state transition, which enables the UE to be configured with training data collection configuration after handover and RRC state transition. In some aspects, for network node-centric training data collection, the serving network node (e.g., a first network node) may release (e.g., no longer maintains, such as by deleting from stored information associated with the particular UE and configure the UE to delete it or mark it as not currently active) the training data collection configuration at the UE during handover or RRC state transition. In some aspects, there may be no training data collection configuration forwarding to the target/candidate cell(s) during handover. In some aspects, training data collection configuration may be maintained at the UE (e.g., if the target/candidate cell(s)/network nodes belong to same infra-vendors based on a configured property ID associated with the network node) during handover/RRC CONNECTED to INACTIVE state transition (e.g., may be paused). In some aspects, training data collection configuration may be reactivated upon transition from INACTIVE to RRC CONNECTED, if maintained at the UE. If the target/candidate network node belongs to different vendors, the UE behavior may be different. In some aspects, the ID that is indicative of the vendor associated with the network node may be based on the actual vendor of the network node or may be based on properties of the network node. In other words, in some aspects, even if the actual vendors are different, the IDs that is indicative of the vendor (e.g., vendor-specific-unique IDs) associated with different network nodes may be the same due to having similar property.

For OAM-centric training data collection, the UE may maintain the training data collection configuration during handover or RRC CONNECTED to INACTIVE state transition (e.g., may be paused). Training data collection configuration may be reactivated upon transition from INACTIVE to RRC CONNECTED, if maintained. Training data collection configuration forwarding to the target/candidate cell(s) during handover may be used. In some aspects, the UE may maintain multiple training data collection configurations (e.g., multiple traces for data collection).

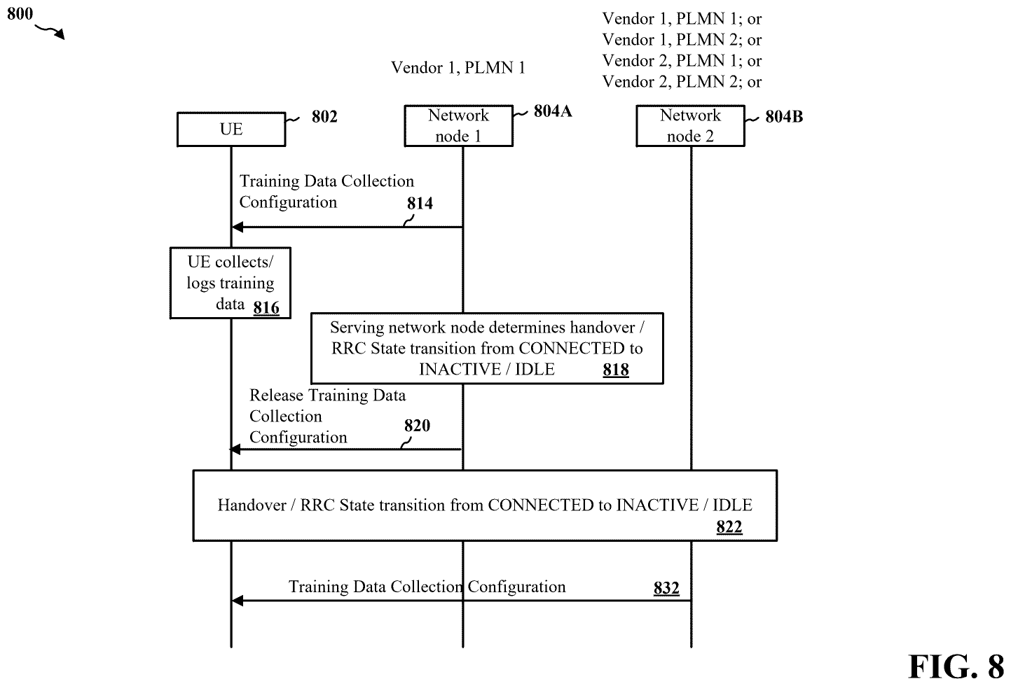

FIG. 8 is a diagram 800 illustrating example communications between a first network node 804A, a second network node 804B, and a UE 802. As illustrated in FIG. 8, the first network node 804A may provide a first training data collection configuration 814 to the UE 802. Based on the first training data collection configuration 814, the UE 802 may, at 816, collect and log training data. At 818, the first network node 804A, which may be a current serving network node for the UE 802, may determine an upcoming handover or RRC state transition from connected to inactive/idle. Based on the determination of the upcoming handover or RRC state transition from connected to inactive/idle, the first network node 804A may transmit a release training data collection configuration 820 to release the first training data collection configuration at the UE 802. Such a transmission of the release may be performed using a “need code” or an explicit indication of the release based on an RRC reconfiguration message. After receiving the release training data collection configuration 820, the UE 802 may release the first training data collection configuration upon handover/RRC state transition from CONNECTED to INACTIVE at 822, as indicated by the serving network node (which may be the first network node 804A) or upon RRC state transition from CONNECTED/INACTIVE to IDLE. After the handover, the UE 802 may receive a second training data collection configuration 832 from the second network node 804B.

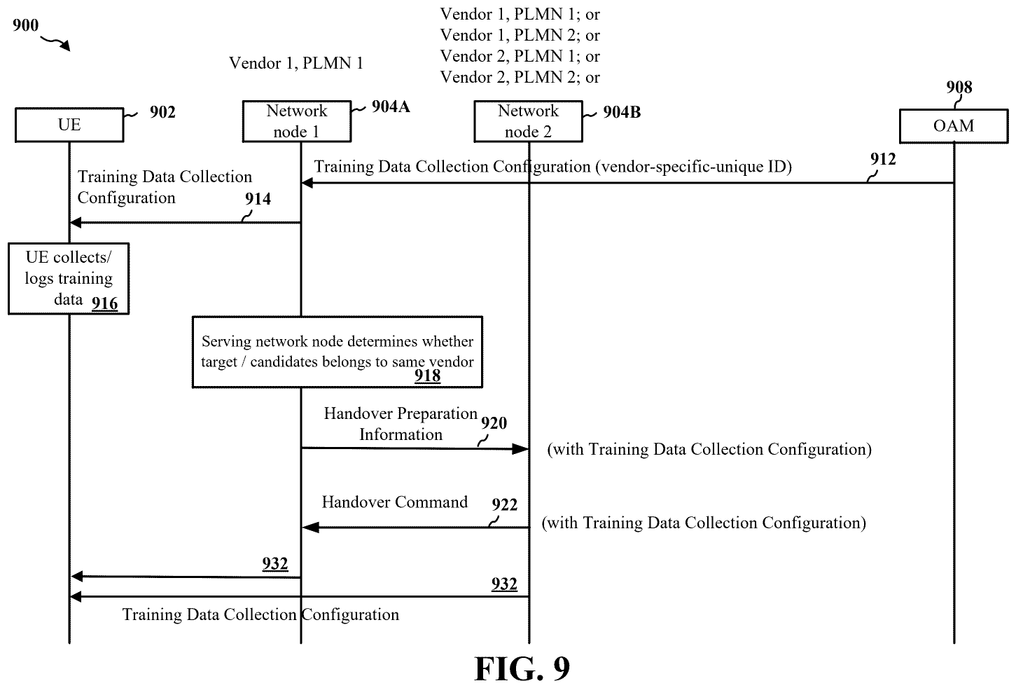

FIG. 9 is a diagram 900 illustrating example communications between a first network node 904A, a second network node 904B, an OAM 908, and a UE 902. The OAM 908 may initiate signaling or management-based training data collection procedures by providing public land mobile networks (PLMNs), type allocation codes (TACs), cell IDs, or frequencies on which training data collection may be performed. The OAM 908 may can select one or more PLMNs, TACs, cell IDs, frequencies, or any combinations of them for training data collection, which may be indicated in a training data collection configuration 912 provided to the first network node 904A, which may be a current serving network node for the UE 902. The training data collection configuration 912 may be provided with or without a vendor-specific-unique ID. In some aspects, the training data collection configuration 912 may be forwarded to the UE 902 as training data collection configuration 914. Upon receiving the training data collection configuration 914, the UE 902 may collect and log training data at 916. The first network node 904A may transmit handover preparation information 920 (e.g., which may include the training data collection configuration) to the second network node 904B. In some aspects, the training data collection configuration is forwarded to the target cells as OCTET String, and target/candidate stores and forwards, if it does not support training data collection, or as OCTET string/RRC, and target/candidate may maintain/modify/release the configuration as needed, if it supports training data collection. The second network node 904B may transmit a handover command 922 back to the first network node 904A. A training data collection configuration 932 (e.g., which may be the same or different from the previous training data collection configuration) may be transmitted to the UE 902 after the handover. The UE 902 may perform action, as configured by the target/candidate cells/network nodes (e.g., the second network node 904B).

In some aspects, the OAM may provision each cell with a vendor-specific unique ID (e.g., which may be based on actual vendor of the network node or based on properties of the network node instead of actual vendors). The ID(s) may be used by network node (network node-CU and network node-DU in split-architecture) to determine whether neighboring cell(s)/network node(s) belongs to same vendor (e.g., have similar properties). In some aspects, the network nodes may share their vendor-specific unique ID with other network nodes over Xn/F1 or with AMF using F1 (between network node-CU and network node-DUs), Xn (between two network nodes or network node-CUs), or NG (between network nodes and AMFs) step-up. During the training data collection configuration at the UE, the IDs may be provided to the UE 902 for pause/re-initiation of the training data collection and reporting. The serving network node (e.g., the first network node 904A) may determine, at 918, if the target or candidates (e.g., the second network node 904B) belongs to the same vendor or have similar properties (e.g., based on the IDs indicative of vendors of the first network node 904A and the second network node 904B being the same). If the first network node 904A and the second network node 904B belongs to the same vendor or have similar properties, in some aspects, the first network node 904A may maintain the training data collection configuration at the UE 902 and the first network node 904A may forward the training data collection configuration to target/candidates (e.g., the second network node 904B). If the first network node 904A and the second network node 904B belongs to different vendors or have different properties (e.g., based on the IDs indicative of vendors of the first network node 904A and the second network node 904B being different), the serving network node (the first network node 904A) may maintain/release the training data collection configuration at the UE 902. For example, if the UE 902 supports maintaining multiple traces or training data collection configuration (e.g., based on a reported capability), the serving network node (the first network node 904A) may maintain (e.g., indicate to maintain) the training data collection configuration at the UE 902 and configure to pause data collection and measurements at the UE 902. In some aspects, the UE 902 may pause data collection and measurements at the UE. In some aspects, if the UE 902 does not support maintaining multiple traces or training data collection configuration (e.g., based on a reported capability), the serving network node (the first network node 904A) may release the training data collection configuration. In some aspects, the serving network node (the first network node 904A) forwards the training data collection configuration to target/candidates (the second network node 904B) in a container (e.g., an OCTET string). In some aspects, the target network node (the second network node 904B) stores and forward data collection configuration container. In some aspects, the target network node (the second network node 904B) checks received training data collection configuration/containers and if the training data collection configuration is paused at the UE 902, the second network node 904B may indicate, in 932, to reinitiate the data collection and reporting at the UE 902 (e.g., based on the ID indicative of the vendor).

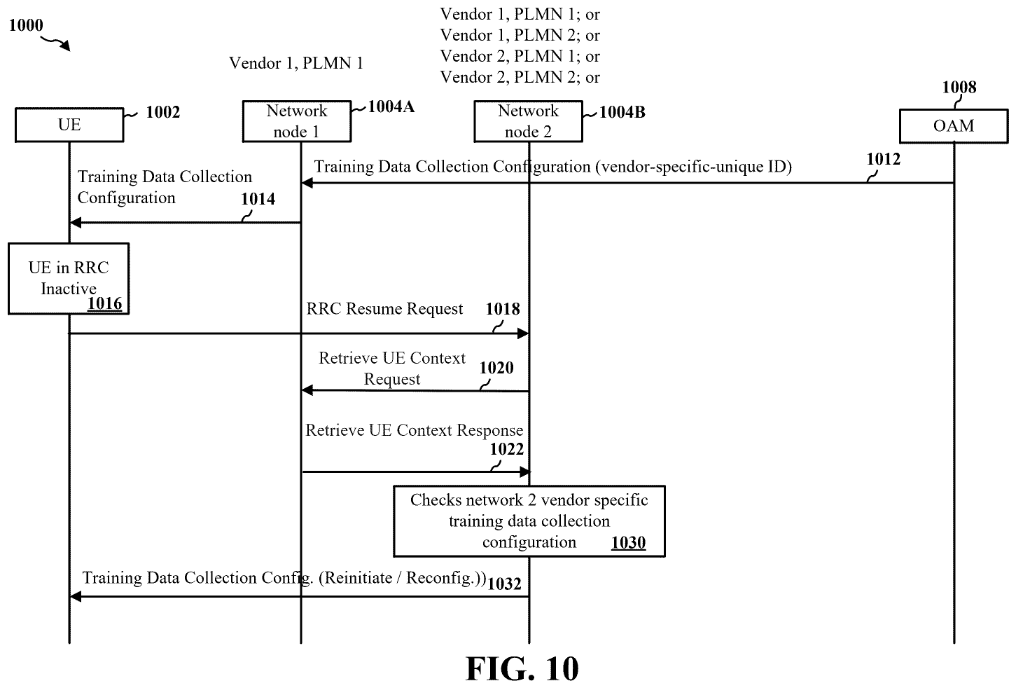

FIG. 10 is a diagram 1000 illustrating example communications between a first network node 1004A, a second network node 1004B, an OAM 1008, and a UE 1002. The OAM 1008 may provide training data collection configuration 1012 may be provided with a vendor-specific-unique ID to the first network node 1004A. In some aspects, the training data collection configuration 1012 may be forwarded to the UE 1002 as training data collection configuration 1014. Upon receiving the training data collection configuration 1014, the UE 1002 may be in an RRC inactive state at 1016. The UE 1002 may transmit an RRC resume request 1018 to the second network node 1004B and in the RRC resume request 1018, stored training data collection configuration (e.g., configuration IDs based on measurement object IDs, reporting object IDs, or logging configuration ID) may be included. The second network node 1004B may retrieve UE context, which may include information regarding the IDs indicative of vendor associated with the training data collection configuration 1014, from previous network node (the first network node 1004A), such as by transmitting retrieve UE context request 1020 and receive retrieve UE context response 1022. The second network node 1004B may check, at 1030, if network node specific data collection configuration is provided to the UE 1002 previously. If yes, at 1032, the second network node 1004B may reinitiate (e.g., if the previously provided training data collection configuration is associated with a same ID indicative of vendor) or reconfigure (e.g., if the previously provided training data collection configuration is associated with an ID indicative of vendor that is different from the second network node 1004B) training data collection configuration and reporting/logging based on stored configuration. If yes, at 1032, the second network node 1004B may reconfigure data collection and reporting/logging based on stored configuration.

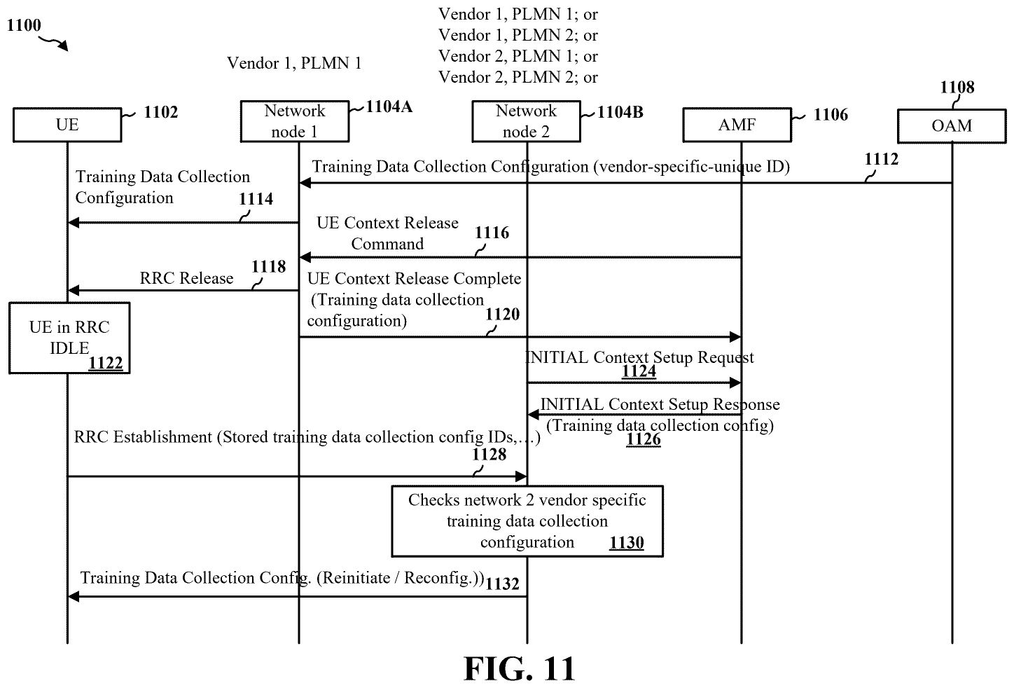

FIG. 11 is a diagram 1100 illustrating example communications between a first network node 1104A, a second network node 1104B, an AMF 1106, an OAM 1108, and a UE 1102. The OAM 1108 may provide training data collection configuration 1112 may be provided with a vendor-specific-unique ID to the first network node 1104A. In some aspects, the training data collection configuration 1112 may be forwarded to the UE 1102 as training data collection configuration 1114. The first network node 1104A may then receive, from the AMF 1106, a UE context release command 1116. After receiving the UE context release command 1116, the first network node 1104A may transmit RRC release 1118 to the UE 1102. The UE 1102 may accordingly enter RRC idle at 1122. The first network node 1104A may also transmit, to the AMF 1106, a UE context release complete 1120, which may include the training data collection configuration 1114. The AMF 1106 may receive initial context setup request 1124 from the second network node 1104B and transmit initial context setup response 1126 to the second network node 1104B. The initial context setup response 1126 may include the training data collection configuration 1114. The UE 1102 may transmit RRC establishment request message 1128 to the second network node 1104B, which may include the stored training data collection configuration IDs (e.g., associated with the training data collection configuration 1114) which may include measurement object IDs, reporting object IDs, or logging configuration ID. The second network node 1104B, which is the network node at which UE performs connection establishment, may retrieve UE context from the AMF 1106 and may check, at 1130, whether the training data collection configuration is previously provided to the UE 1102. If yes, at 1132, the second network node 1104B may reinitiate (e.g., if the previously provided training data collection configuration is associated with an ID indicative of vendor that is the same as the vendor of the second network node 1104B) or reconfigure (e.g., if the previously provided training data collection configuration is associated with an ID indicative of vendor that is different from the second network node 1104B) data collection and reporting/logging based on stored configuration. If no, at 1132, the second network node 1104B may reconfigure data collection and reporting/logging based on stored configuration.

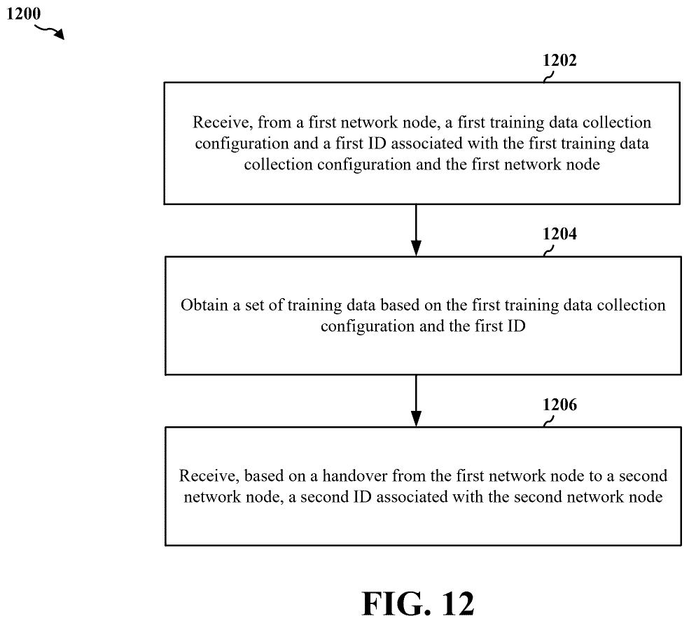

FIG. 12 is a flowchart 1200 of a method of wireless communication. The method may be performed by a UE (e.g., the UE 104, the UE 802, the UE 902, the UE 1002, the UE 1102; the apparatus 1604).

At 1202, the UE may receive, from a first network node, a first training data collection configuration and a first ID associated with the first training data collection configuration and the first network node, where the first ID is indicative of a first vendor associated with the first network node. For example, the UE (e.g., 802, 902, 1002, 1102) may receive, from a first network node (e.g., 804A, 904A, 1004A, 1104A), a first training data collection configuration (e.g., 814, 914, 1014, 1114) and a first ID associated with the first training data collection configuration and the first network node, where the first ID is indicative of a first vendor associated with the first network node. In some aspects, 1202 may be performed by collection configuration component 198.

At 1204, the UE may obtain a set of training data based on the first training data collection configuration and the first ID. For example, the UE (e.g., 802, 902, 1002, 1102) may obtain a set of training data (e.g., at 816 or 916) based on the first training data collection configuration and the first ID. In some aspects, 1204 may be performed by collection configuration component 198. In some aspects, obtaining the set of training data may include locally collecting and storing the training data. In some aspects, obtaining the set of training data may include a collaborative effort with other UEs where the UE may exchange training data with other UEs.

At 1206, the UE may receive, based on a handover from the first network node to a second network node, a second ID associated with the second network node, where the second ID is indicative of a second vendor associated with the second network node. For example, the UE (e.g., 802, 902, 1002, 1102) may receive, based on a handover from the first network node (e.g., 804A, 904A, 1004A, 1104A) to a second network node (e.g., 804B, 904B, 1004B, 1104B), a second ID associated with the second network node, where the second ID is indicative of a second vendor associated with the second network node. In some aspects, 1206 may be performed by collection configuration component 198.

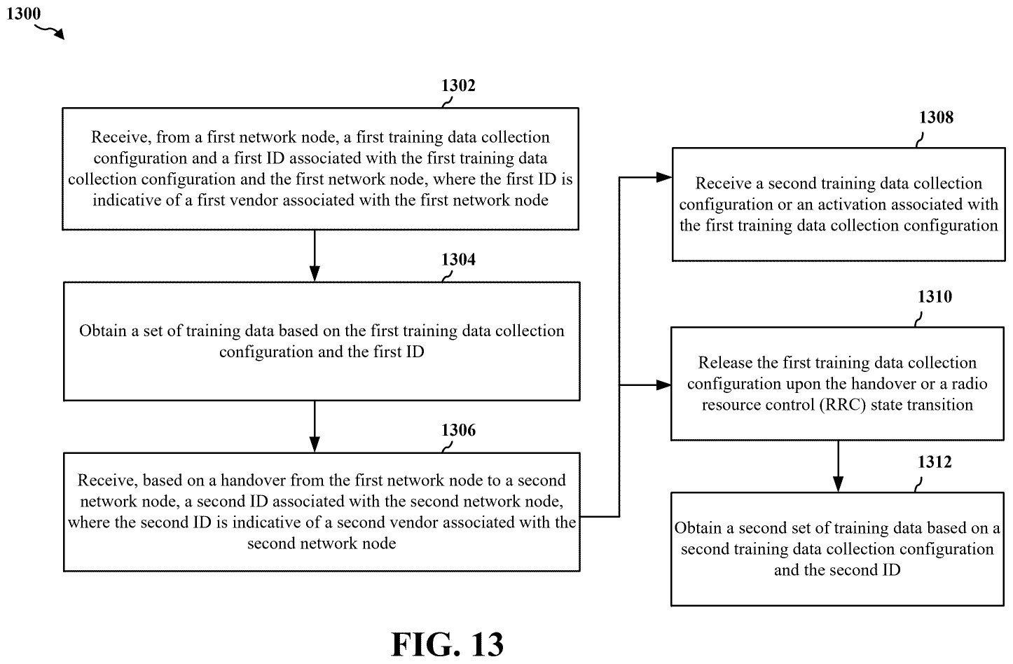

FIG. 13 is a flowchart 1300 of a method of wireless communication. The method may be performed by a UE (e.g., the UE 104, the UE 802, the UE 902, the UE 1002, the UE 1102; the apparatus 1604).

At 1302, the UE may receive, from a first network node, a first training data collection configuration and a first ID associated with the first training data collection configuration and the first network node, where the first ID is indicative of a first vendor associated with the first network node. For example, the UE (e.g., 802, 902, 1002, 1102) may receive, from a first network node (e.g., 804A, 904A, 1004A, 1104A), a first training data collection configuration (e.g., 814, 914, 1014, 1114) and a first ID associated with the first training data collection configuration and the first network node, where the first ID is indicative of a first vendor associated with the first network node. In some aspects, 1302 may be performed by collection configuration component 198.

At 1304, the UE may obtain a set of training data based on the first training data collection configuration and the first ID. For example, the UE (e.g., 802, 902, 1002, 1102) may obtain a set of training data (e.g., at 816 or 916) based on the first training data collection configuration and the first ID. In some aspects, 1304 may be performed by collection configuration component 198. In some aspects, obtaining the set of training data may include locally collecting and storing the training data. In some aspects, obtaining the set of training data may include a collaborative effort with other UEs where the UE may exchange training data with other UEs.

At 1306, the UE may receive, based on a handover from the first network node to a second network node, a second ID associated with the second network node, where the second ID is indicative of a second vendor associated with the second network node. For example, the UE (e.g., 802, 902, 1002, 1102) may receive, based on a handover from the first network node (e.g., 804A, 904A, 1004A, 1104A) to a second network node (e.g., 804B, 904B, 1004B, 1104B), a second ID associated with the second network node, where the second ID is indicative of a second vendor associated with the second network node. In some aspects, 1306 may be performed by collection configuration component 198.

In some aspects, at 1308, the UE may receive a second training data collection configuration or an activation (e.g., 932, 1032, 1132) associated with the first training data collection configuration. In some aspects, 1308 may be performed by collection configuration component 198.

In some aspects, at 1310, the UE may release the first training data collection configuration (e.g., upon reception of 820) upon the handover or an RRC state transition. In some aspects, 1310 may be performed by collection configuration component 198.

In some aspects, at 1312, the UE may obtain a second set of training data based on a second training data collection configuration (e.g., 832, 932, 1032, 1132) and the second ID. In some aspects, 1312 may be performed by collection configuration component 198. In some aspects, to obtain the second set of training data based on the second training data collection configuration and the second ID, the UE may collect and store the second set of training data based on the second training data collection configuration and the second ID.

In some aspects, to obtain the set of training data based on the first training data collection configuration and the first ID, the UE may collect and store the set of training data based on the first training data collection configuration and the first ID.

In some aspects, the first vendor is identical to the second vendor, and the UE may pause collection of the set of training data based on the first training data collection configuration, maintain storage of the first training data collection configuration, and collect and store a second set of training data based on the first training data collection configuration and the second ID.

In some aspects, the UE may transmit, in an RRC inactive state to the second network node, an RRC resume request (e.g., 1018), where the RRC resume request includes the set of training data and receive (e.g., 1032) a second training data collection configuration or an activation (e.g., re-initiation) associated with the first training data collection configuration after transmission of the RRC resume request.

In some aspects, the UE may transmit, in a radio resource control (RRC) idle state to the second network node, an RRC establishment request (e.g., 1128), where the RRC establishment request includes the set of training data and receive a second training data collection configuration or an activation associated with the first training data collection configuration after transmission of the RRC establishment request.

In some aspects, the first training data collection configuration includes at least one of: a set of measurement object IDs, a set of reporting object IDs, or a logging configuration ID.

In some aspects, the UE may store the second ID and maintain a storage of the first training data collection configuration after the reception of the second ID, where the second vendor is different from the first vendor. In some aspects, the first training data collection configuration includes at least one of: a set of measurement object IDs, a set of reporting object IDs, or a logging configuration ID. In some aspects, the second training data collection configuration includes at least one of: a set of measurement object IDs, a set of reporting object IDs, or a logging configuration ID.

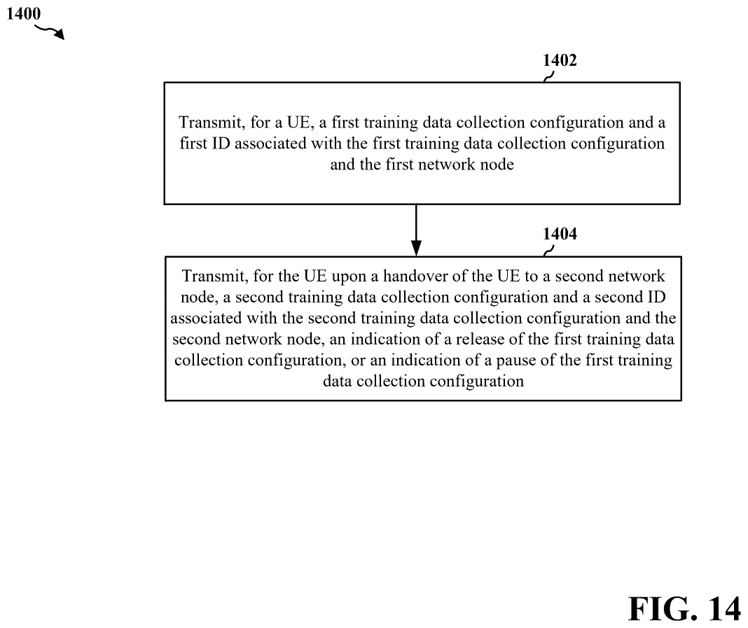

FIG. 14 is a flowchart 1400 of a method of wireless communication. The method may be performed by a network entity (e.g., the base station 102, the network entity 1602, the network entity 1702).

At 1402, the first network node may transmit, for a UE, a first training data collection configuration and a first ID associated with the first training data collection configuration and the first network node, where the first ID is indicative of a first vendor associated with the first network node. For example, the first network node (e.g., 804A, 904A, 1004A, 1104A) may transmit, for a UE, a first training data collection configuration (e.g., 814, 914, 1014, 1114) and a first ID associated with the first training data collection configuration and the first network node, where the first ID is indicative of a first vendor associated with the first network node. In some aspects, 1402 may be performed by collection configuration component 199.

At 1404, the first network node may transmit, for the UE upon a handover of the UE to a second network node, a second training data collection configuration and a second ID associated with the second training data collection configuration and the second network node, an indication of a release of the first training data collection configuration, or an indication of a pause of the first training data collection configuration. For example, the first network node (e.g., 804A, 904A, 1004A, 1104A) may transmit, for the UE upon a handover of the UE to a second network node (e.g., 804B, 904B, 1004B, 1104B), a second training data collection configuration (e.g., 932) and a second ID associated with the second training data collection configuration and the second network node, an indication of a release (e.g., 820) of the first training data collection configuration, or an indication of a pause of the first training data collection configuration. In some aspects, 1404 may be performed by collection configuration component 199.

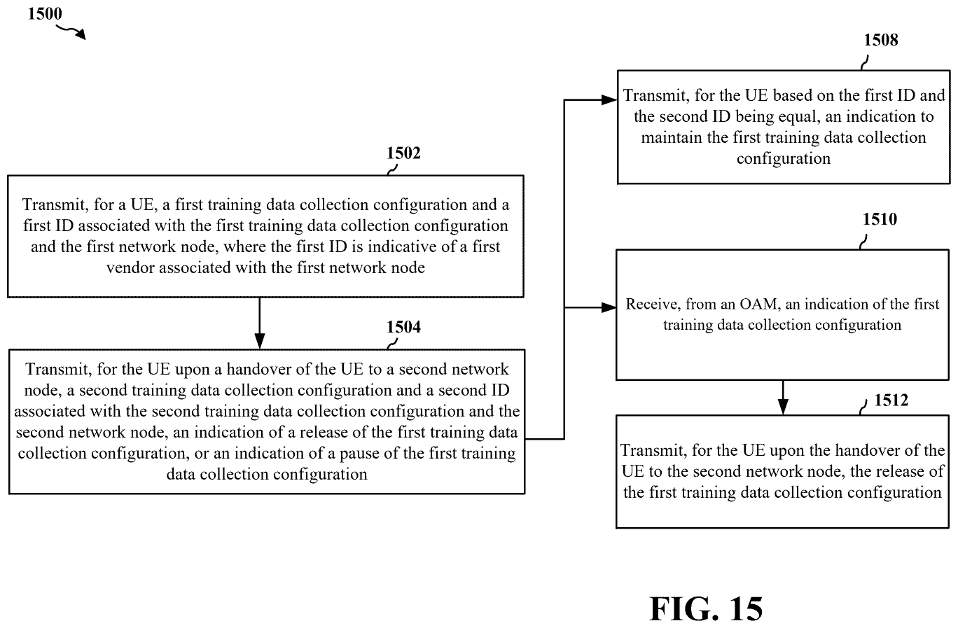

FIG. 15 is a flowchart 1500 of a method of wireless communication. The method may be performed by a network entity (e.g., the base station 102, the network entity 1502, the network entity 1502).

At 1502, the first network node may transmit, for a UE, a first training data collection configuration and a first ID associated with the first training data collection configuration and the first network node, where the first ID is indicative of a first vendor associated with the first network node. For example, the first network node (e.g., 804A, 904A, 1004A, 1104A) may transmit, for a UE, a first training data collection configuration (e.g., 814, 914, 1014, 1114) and a first ID associated with the first training data collection configuration and the first network node, where the first ID is indicative of a first vendor associated with the first network node. In some aspects, 1502 may be performed by collection configuration component 199.

At 1504, the first network node may transmit, for the UE upon a handover of the UE to a second network node, a second training data collection configuration and a second ID associated with the second training data collection configuration and the second network node, an indication of a release of the first training data collection configuration, or an indication of a pause of the first training data collection configuration. For example, the first network node (e.g., 804A, 904A, 1004A, 1104A) may transmit, for the UE upon a handover of the UE to a second network node (e.g., 804B, 904B, 1004B, 1104B), a second training data collection configuration (e.g., 932) and a second ID associated with the second training data collection configuration and the second network node, an indication of a release (e.g., 820) of the first training data collection configuration, or an indication of a pause of the first training data collection configuration. In some aspects, 1504 may be performed by collection configuration component 199.

In some aspects, at 1510, the first network node may receive, from an OAM, an indication of the first training data collection configuration (e.g., 912, 1012, 1112) and transmit, for the UE upon the handover of the UE to the second network node, the second training data collection configuration and the second ID associated with the second training data collection configuration and the second network node.

In some aspects, the indication includes at least one of: the first ID, a cell ID associated with the first network node, a public land mobile network associated with the first network node, a type allocation code (TAC) associated with the first network node, or at least one frequency associated with the first training data collection configuration.

In some aspects, at 1512, the first network node may transmit, for the UE upon the handover of the UE to the second network node, the release (e.g., 820) of the first training data collection configuration. In some aspects, 1512 may be performed by collection configuration component 199.

In some aspects, the first network node may receive, from an OAM, the second ID, transmit, for the UE based on the first ID and the second ID being equal, an indication to maintain the first training data collection configuration, and transmit, for the second network node, the first training data collection configuration.

In some aspects, the first network node may receive, from an OAM, the second ID, transmit, to the UE based on the first ID and the second ID being equal, an indication to maintain the first training data collection configuration, and transmit, for the second network node, the first training data collection configuration (e.g., in 920 or 1022).

In some aspects, the first network node may receive, from an OAM, the second ID. In some aspects, the first network may, at 1508, transmit, for the UE based on the first ID and the second ID being equal, an indication (e.g., at 932) to maintain the first training data collection configuration based on the UE supports maintenance of multiple training data collection configurations or the release of the first training data collection configuration based on the UE does not support the maintenance of the multiple training data collection configurations. In some aspects, 1508 may be performed by collection configuration component 199.

In some aspects, the first network node may transmit, for the second network node, a container of the first training data collection configuration. In some aspects, the indication includes at least one of: the first ID, a cell ID associated with the first network node, a public land mobile network associated with the first network node, a type allocation code (TAC) associated with the first network node, or at least one frequency associated with the first training data collection configuration.

In some aspects, the first network node may receive, from an access and mobility function (AMF) (e.g., 1106), a UE context release command (e.g., 1116), transmit, for the UE based on the UE context release command, a radio resource control (RRC) release (e.g., 1118), and transmit, for the AMF, UE context release complete (e.g., 1120) indication including the first training data collection configuration.

In some aspects, the first network node may transmit, for the second network node, the first ID, and receive, from the second network node, the second ID.

In some aspects, the first network node may receive, from an access and mobility function (AMF), the second ID, and transmit, for the second network node, the first ID. In some aspects, the first training data collection configuration includes at least one of: a set of measurement object IDs, a set of reporting object IDs, or a logging configuration ID.

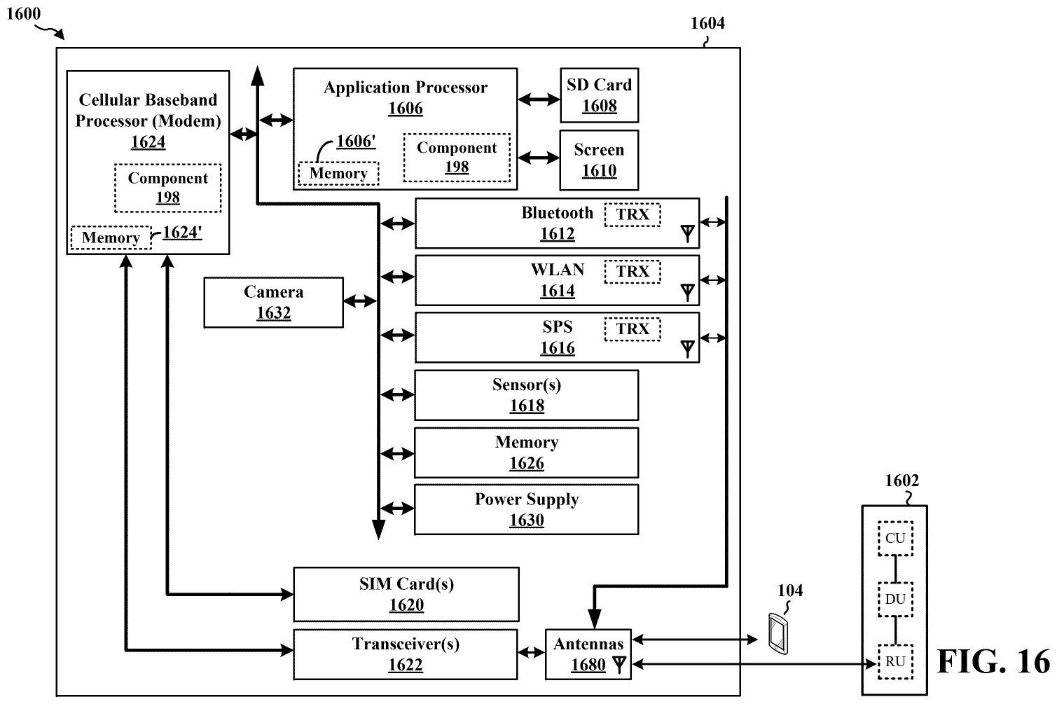

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the collection configuration component 198 may be configured to receive, from a first network node, a first training data collection configuration and a first identifier (ID) associated with the first training data collection configuration and the first network node, where the first ID is indicative of a first vendor associated with the first network node. In some aspects, the collection configuration component 198 may be further configured to obtain a set of training data based on the first training data collection configuration and the first ID. In some aspects, the collection configuration component 198 may be further configured to receive, based on a handover from the first network node to a second network node, a second ID associated with the second network node, where the second ID is indicative of a second vendor associated with the second network node. The collection configuration component 198 may be within the cellular baseband processor(s) 1624, the application processor(s) 1606, or both the cellular baseband processor(s) 1624 and the application processor(s) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for receiving, from a first network node, a first training data collection configuration and a first identifier (ID) associated with the first training data collection configuration and the first network node, where the first ID is indicative of a first vendor associated with the first network node. In some aspects, the apparatus 1604 may include means for obtaining a set of training data based on the first training data collection configuration and the first ID. In some aspects, the apparatus 1604 may include means for receiving, based on a handover from the first network node to a second network node, a second ID associated with the second network node, where the second ID is indicative of a second vendor associated with the second network node. In some aspects, the apparatus 1604 may include means for releasing the first training data collection configuration upon the handover or a radio resource control (RRC) state transition. In some aspects, the apparatus 1604 may include means for obtaining a second set of training data based on a second training data collection configuration and the second ID. In some aspects, the apparatus 1604 may include means for collecting and storing the second set of training data based on the second training data collection configuration and the second ID. In some aspects, the apparatus 1604 may include means for collecting and storing the set of training data based on the first training data collection configuration and the first ID. In some aspects, the apparatus 1604 may include means for pausing collection of the set of training data based on the first training data collection configuration. In some aspects, the apparatus 1604 may include means for maintaining storage of the first training data collection configuration. In some aspects, the apparatus 1604 may include means for collecting and storing a second set of training data based on the first training data collection configuration and the second ID. In some aspects, the apparatus 1604 may include means for transmitting, in a radio resource control (RRC) inactive state to the second network node, an RRC resume request, where the RRC resume request includes the set of training data. In some aspects, the apparatus 1604 may include means for receiving a second training data collection configuration or an activation associated with the first training data collection configuration after transmission of the RRC resume request. In some aspects, the apparatus 1604 may include means for transmitting, in a radio resource control (RRC) idle state to the second network node, an RRC establishment request, where the RRC establishment request includes the set of training data. In some aspects, the apparatus 1604 may include means for receiving a second training data collection configuration or an activation associated with the first training data collection configuration after transmission of the RRC establishment request. In some aspects, the apparatus 1604 may include means for storing the second ID with a second training data collection configuration after the reception of the second ID. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

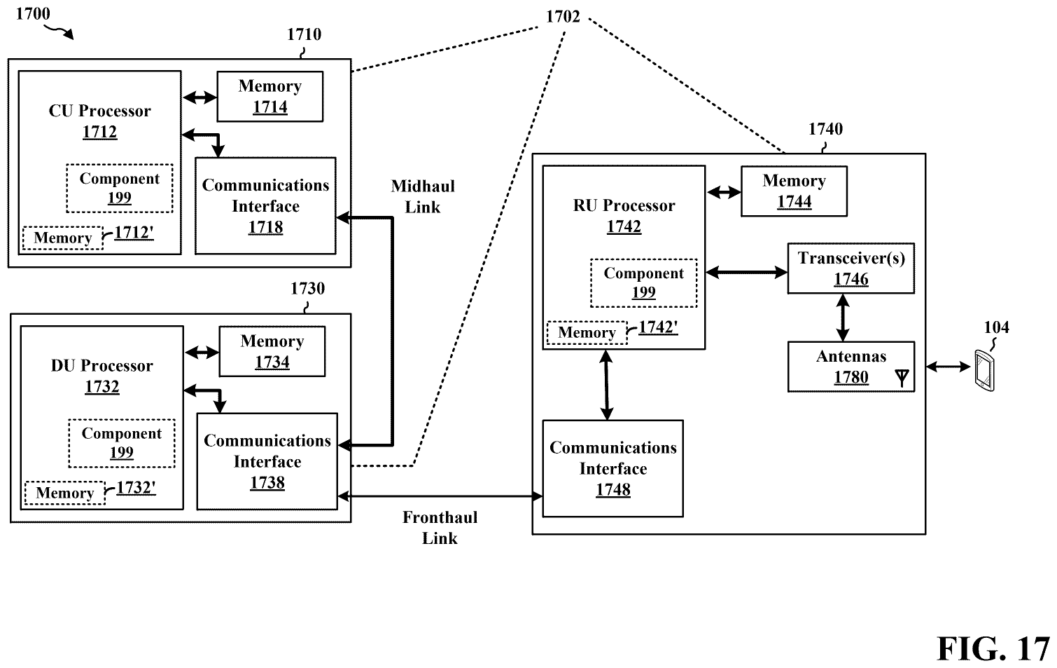

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the collection configuration component 199 may be configured to transmit, for a user equipment (UE), a first training data collection configuration and a first identifier (ID) associated with the first training data collection configuration and the first network node, where the first ID is indicative of a first vendor associated with the first network node. In some aspects, the collection configuration component 199 may be further configured to transmit, for the UE upon a handover of the UE to a second network node, a second training data collection configuration and a second ID associated with the second training data collection configuration and the second network node, an indication of a release of the first training data collection configuration, or an indication of a pause of the first training data collection configuration. The collection configuration component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for transmitting, for a user equipment (UE), a first training data collection configuration and a first identifier (ID) associated with the first training data collection configuration and the first network node, where the first ID is indicative of a first vendor associated with the first network node. In some aspects, the network entity 1702 may include means for transmitting, for the UE upon a handover of the UE to a second network node, a second training data collection configuration and a second ID associated with the second training data collection configuration and the second network node, an indication of a release of the first training data collection configuration, or an indication of a pause of the first training data collection configuration. In some aspects, the network entity 1702 may include means for receiving, from an operations administration and maintenance (OAM), an indication of the first training data collection configuration. In some aspects, the network entity 1702 may include means for transmitting, for the UE upon the handover of the UE to the second network node, the second training data collection configuration and the second ID associated with the second training data collection configuration and the second network node. In some aspects, the network entity 1702 may include means for transmitting, for the UE upon the handover of the UE to the second network node, the release of the first training data collection configuration. In some aspects, the network entity 1702 may include means for receiving, from an operations administration and maintenance (OAM), the second ID. In some aspects, the network entity 1702 may include means for transmitting, for the UE based on the first ID and the second ID being equal, an indication to maintain the first training data collection configuration. In some aspects, the network entity 1702 may include means for transmitting, for the second network node, the first training data collection configuration. In some aspects, the network entity 1702 may include means for receiving, from an operations administration and maintenance (OAM), the second ID. In some aspects, the network entity 1702 may include means for transmitting, to the UE based on the first ID and the second ID being equal, an indication to maintain the first training data collection configuration. In some aspects, the network entity 1702 may include means for transmitting, for the second network node, the first training data collection configuration. In some aspects, the network entity 1702 may include means for receiving, from an operations administration and maintenance (OAM), the second ID. In some aspects, the network entity 1702 may include means for transmitting, for the UE based on the first ID and the second ID being equal, an indication to maintain the first training data collection configuration based on the UE supports maintenance of multiple training data collection configurations or the release of the first training data collection configuration based on the UE does not support the maintenance of the multiple training data collection configurations. In some aspects, the network entity 1702 may include means for transmitting, for the second network node, a container of the first training data collection configuration. In some aspects, the network entity 1702 may include means for receiving, from an access and mobility function (AMF), a UE context release command. In some aspects, the network entity 1702 may include means for transmitting, for the UE based on the UE context release command, a radio resource control (RRC) release. In some aspects, the network entity 1702 may include means for transmitting, for the AMF, UE context release complete indication including the first training data collection configuration. In some aspects, the network entity 1702 may include means for transmitting, for the second network node, the first ID. In some aspects, the network entity 1702 may include means for receiving, from the second network node, the second ID. In some aspects, the network entity 1702 may include means for receiving, from an access and mobility function (AMF), the second ID. In some aspects, the network entity 1702 may include means for transmitting, for the second network node, the first ID. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, based at least in part on information stored in the at least one memory, the at least one processor is configured to: receive, from a first network node, a first training data collection configuration and a first identifier (ID) associated with the first training data collection configuration and the first network node, where the first ID is indicative of a first vendor associated with the first network node; obtain a set of training data based on the first training data collection configuration and the first ID; and receive, based on a handover from the first network node to a second network node, a second ID associated with the second network node, where the second ID is indicative of a second vendor associated with the second network node.

Aspect 2 is the apparatus of aspect 1, where the at least one processor is further configured to: release the first training data collection configuration upon the handover or a radio resource control (RRC) state transition; and obtain a second set of training data based on a second training data collection configuration and the second ID.

Aspect 3 is the apparatus of any of aspects 1-2, where to obtain the second set of training data based on the second training data collection configuration and the second ID, the at least one processor is configured to: collect and store the second set of training data based on the second training data collection configuration and the second ID.

Aspect 4 is the apparatus of any of aspects 1-3, where to obtain the set of training data based on the first training data collection configuration and the first ID, the at least one processor is configured to: collect and store the set of training data based on the first training data collection configuration and the first ID.

Aspect 5 is the apparatus of aspect 4, where the first vendor is identical to the second vendor, and where the at least one processor is further configured to: pause collection of the set of training data based on the first training data collection configuration; maintain storage of the first training data collection configuration; and collect and store a second set of training data based on the first training data collection configuration and the second ID.

Aspect 6 is the apparatus of any of aspects 1-5, where the at least one processor is further configured to: transmit, in a radio resource control (RRC) inactive state to the second network node, an RRC resume request, where the RRC resume request includes the set of training data; and receive a second training data collection configuration or an activation associated with the first training data collection configuration after transmission of the RRC resume request.

Aspect 7 is the apparatus of any of aspects 1-6, where the at least one processor is further configured to: transmit, in a radio resource control (RRC) idle state to the second network node, an RRC establishment request, where the RRC establishment request includes the set of training data; and receive a second training data collection configuration or an activation associated with the first training data collection configuration after transmission of the RRC establishment request.

Aspect 8 is the apparatus of any of aspects 1-7, where the first training data collection configuration includes at least one of: a set of measurement object IDs, a set of reporting object IDs, or a logging configuration ID.

Aspect 9 is the apparatus of any of aspects 1-8, where the at least one processor is further configured to: store the second ID with a second training data collection configuration and maintain a storage of the first training data collection configuration after the reception of the second ID, where the second vendor (e.g., based on the ID) is different from the first vendor (e.g., based on the ID).

Aspect 10 is an apparatus for wireless communication at a first network node, including: at least one memory; and at least one processor coupled to the at least one memory, based at least in part on information stored in the at least one memory, the at least one processor is configured to: transmit, for a user equipment (UE), a first training data collection configuration and a first identifier (ID) associated with the first training data collection configuration and the first network node, where the first ID is indicative of a first vendor associated with the first network node; and transmit, for the UE upon a handover of the UE to a second network node, a second training data collection configuration and a second ID associated with the second training data collection configuration and the second network node, an indication of a release of the first training data collection configuration, or an indication of a pause of the first training data collection configuration.

Aspect 11 is the apparatus of aspect 10, where the at least one processor is further configured to: receive, from an operations administration and maintenance (OAM), an indication of the first training data collection configuration; and transmit, for the UE upon the handover of the UE to the second network node, the second training data collection configuration and the second ID associated with the second training data collection configuration and the second network node.

Aspect 12 is the apparatus of aspect 11, where the indication includes at least one of: the first ID, a cell ID associated with the first network node, a public land mobile network associated with the first network node, a type allocation code (TAC) associated with the first network node, or at least one frequency associated with the first training data collection configuration, and where the first training data collection configuration includes at least one of: a set of measurement object IDs, a set of reporting object IDs, or a logging configuration ID.

Aspect 13 is the apparatus of any of aspects 10-12, where the at least one processor is further configured to: transmit, for the UE upon the handover of the UE to the second network node, the release of the first training data collection configuration.

Aspect 14 is the apparatus of any of aspects 10-13, where the at least one processor is further configured to: receive, from an operations administration and maintenance (OAM), the second ID; transmit, for the UE based on the first ID and the second ID being equal, an indication to maintain the first training data collection configuration; and transmit, for the second network node, the first training data collection configuration.

Aspect 15 is the apparatus of any of aspects 10-14, where the at least one processor is further configured to: receive, from an operations administration and maintenance (OAM), the second ID; transmit, to the UE based on the first ID and the second ID being equal, an indication to maintain the first training data collection configuration; and transmit, for the second network node, the first training data collection configuration.

Aspect 16 is the apparatus of any of aspects 10-15, where the at least one processor is further configured to: receive, from an operations administration and maintenance (OAM), the second ID; transmit, for the UE based on the first ID and the second ID being equal, an indication to maintain the first training data collection configuration based on the UE supports maintenance of multiple training data collection configurations or the release of the first training data collection configuration based on the UE does not support the maintenance of the multiple training data collection configurations; and transmit, for the second network node, a container of the first training data collection configuration.

Aspect 17 is the apparatus of any of aspects 10-16, where the at least one processor is further configured to: receive, from an access and mobility function (AMF), a UE context release command; transmit, for the UE based on the UE context release command, a radio resource control (RRC) release; and transmit, for the AMF, UE context release complete indication including the first training data collection configuration.

Aspect 18 is the apparatus of any of aspects 10-17, where the at least one processor is further configured to: transmit, for the second network node, the first ID; and receive, from the second network node, the second ID.

Aspect 19 is the apparatus of any of aspects 10-18, where the at least one processor is further configured to: receive, from an access and mobility function (AMF), the second ID; and transmit, for the second network node, the first ID.

Aspect 20 is a method of wireless communication for implementing any of aspects 1 to 19.

Aspect 21 is a computer-readable medium (e.g., a non-transitory computer-readable medium) storing computer executable code, the code when executed by at least one processor causes the at least one processor to implement any of aspects 1 to 19.

Aspect 22 is an apparatus comprising means for implementing any of aspects 1 to 19.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
receive, from a first network node, a first training data collection configuration and a first identifier (ID) associated with the first training data collection configuration and the first network node;
obtain a set of training data based on the first training data collection configuration and the first ID; and
receive, based on a handover from the first network node to a second network node, a second ID associated with the second network node.

2. The apparatus of claim 1, wherein the at least one processor is further configured to:
release the first training data collection configuration upon the handover or a radio resource control (RRC) state transition; and
obtain a second set of training data based on a second training data collection configuration and the second ID.

3. The apparatus of claim 2, wherein to obtain the second set of training data based on the second training data collection configuration and the second ID, the at least one processor is configured to:
collect and store the second set of training data based on the second training data collection configuration and the second ID.

4. The apparatus of claim 1, wherein the first ID is indicative of a first vendor associated with the first network node and wherein the second ID is indicative of a second vendor associated with the second network node.

5. The apparatus of claim 4, wherein to obtain the set of training data based on the first training data collection configuration and the first ID, the at least one processor is configured to:
collect and store the set of training data based on the first training data collection configuration and the first ID.

6. The apparatus of claim 5, wherein the first vendor is identical to the second vendor, and wherein the at least one processor is further configured to:
pause collection of the set of training data based on the first training data collection configuration;
maintain storage of the first training data collection configuration; and
collect and store a second set of training data based on the first training data collection configuration and of the second ID.

7. The apparatus of claim 1, wherein the at least one processor is further configured to:
transmit, in a radio resource control (RRC) inactive state to the second network node, an RRC resume request, wherein the RRC resume request comprises the set of training data; and
receive a second training data collection configuration or an activation associated with the first training data collection configuration after transmission of the RRC resume request.

8. The apparatus of claim 1, wherein the first training data collection configuration comprises at least one of: a set of measurement object IDs, a set of reporting object IDs, or a logging configuration ID.

9. The apparatus of claim 1, wherein the at least one processor is further configured to:
store the second ID with a second training data collection configuration and maintain a storage of the first training data collection configuration after reception of the second ID, wherein the second ID is different from the first ID.

10. An apparatus for wireless communication at a first network node, comprising:
at least one memory; and
at least one processor coupled to the at least one memory, based at least in part on information stored in the at least one memory, the at least one processor is configured to:
transmit, for a user equipment (UE), a first training data collection configuration and a first identifier (ID) associated with the first training data collection configuration and the first network node, wherein the first ID is indicative of a first vendor associated with the first network node; and
transmit, for the UE upon a handover of the UE to a second network node, a second training data collection configuration and a second ID associated with the second training data collection configuration and the second network node, an indication of a release of the first training data collection configuration, or an indication of a pause of the first training data collection configuration.

11. The apparatus of claim 10, wherein the at least one processor is further configured to:
receive, from an operations administration and maintenance (OAM), an indication of the first training data collection configuration; and
transmit, for the UE upon the handover of the UE to the second network node, the second training data collection configuration and the second ID associated with the second training data collection configuration and the second network node.

12. The apparatus of claim 11, wherein the indication comprises at least one of: the first ID, a cell ID associated with the first network node, a public land mobile network associated with the first network node, a type allocation code (TAC) associated with the first network node, or at least one frequency associated with the first training data collection configuration, and wherein the first training data collection configuration comprises at least one of: a set of measurement object IDs, a set of reporting object IDs, or a logging configuration ID.

13. The apparatus of claim 10, wherein the at least one processor is further configured to:
transmit, for the UE upon the handover of the UE to the second network node, the release of the first training data collection configuration.

14. The apparatus of claim 10, wherein the at least one processor is further configured to:
receive, from an operations administration and maintenance (OAM), the second ID;
transmit, for the UE based on the first ID and the second ID being equal, an indication to maintain the first training data collection configuration; and
transmit, for the second network node, the first training data collection configuration.

15. The apparatus of claim 10, wherein the at least one processor is further configured to:
receive, from an operations administration and maintenance (OAM), the second ID;
transmit, to the UE based on the first ID and the second ID being equal, an indication to maintain the first training data collection configuration; and
transmit, for the second network node, the first training data collection configuration.

16. The apparatus of claim 10, wherein the at least one processor is further configured to:
receive, from an operations administration and maintenance (OAM), the second ID;
transmit, for the UE based on the first ID and the second ID being equal, an indication to maintain the first training data collection configuration based on the UE supports maintenance of multiple training data collection configurations or the release of the first training data collection configuration based on the UE does not support the maintenance of the multiple training data collection configurations; and
transmit, for the second network node, a container of the first training data collection configuration.

17. The apparatus of claim 10, wherein the at least one processor is further configured to:
receive, from an access and mobility function (AMF), a UE context release command;
transmit, for the UE based on the UE context release command, a radio resource control (RRC) release; and
transmit, for the AMF, UE context release complete indication comprising the first training data collection configuration.

18. The apparatus of claim 10, wherein the at least one processor is further configured to:
transmit, for the second network node, the first ID; and
receive, from the second network node, the second ID.

19. The apparatus of claim 10, wherein the at least one processor is further configured to:
receive, from an access and mobility function (AMF), the second ID; and
transmit, for the second network node, the first ID.

20. A method of wireless communication at a user equipment (UE), comprising:
receiving, from a first network node, a first training data collection configuration and a first identifier (ID) associated with the first training data collection configuration and the first network node;
obtaining a set of training data based on the first training data collection configuration and the first ID; and
receiving, based on a handover from the first network node to a second network node, a second ID associated with the second network node.
